(19) United States
(12) Patent Application Publication
(10) Pub. No.: US 2007/0136150 A1
(43) Pub. Date: Jun. 14, 2007

(54) Identifying potential modifications of a shipping item design

(76) Inventors: Perry L. Biancavilla, Boise, ID (US); Miles K. Thorland, Ft. Collins, CO (US); Elisabeth Jane Melia, Palo Alto, CA (US); Matthew P. Daum, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/288,606

(22) Filed: Nov. 29, 2005

(51) Int. Cl. G06Q 10/00

(52) U.S. Cl. 705/28

(57) ABSTRACT

Systems and methods of identifying potential modifications of a shipping item design are described. In one aspect, a first number of homogeneous copies of the shipping item in a first design state that fit on a specified shipping pallet is identified. One or more modifications of the shipping item's design are computed. The computed modifications transform the first design state into a second design state of the shipping item homogeneous copies of which fit on the specified shipping pallet in a second number greater than the first number.

### BACKGROUND

Many product design processes begin with identifying a customer or marketplace need and end with manufacturing a product that satisfies the need. The design of a new product typically proceeds through a series of design stages: from an initial problem statement stage, through conceptual and detailed product design specification stages, to a manufacturing and testing stage. Product designers commonly proceed sequentially through these design stages. When problems or desirable modifications to a product's design are recognized at a particular design stage, the product designers typically must return to a preceding design stage to implement the modifications. Such iterations in the product design process tend to increase costs and production delays. To avoid such costs and delays, product designers try to identify desirable product design modifications and eliminate potential design problems as early as possible in the product design process. The process of identifying desirable product design modifications and potential design problems typically involves working with a disconnected collection of design and analysis tools in an ad hoc way that depends largely on the preferences and experiences of a product designer.

Freight and packaging costs are two of many costs that are associated with product manufacturing. During the product design process, a package engineer typically uses the specifications for a prototype of a product being designed to devise packaging that allows safe transport of the product. Among the product specifications that affect the selected package design are the estimated size and weight of the product, the expected robustness of the product, location of accessories (i.e., power cords, keyboards, etc.), and the expected shipping orientation of the product. Among the factors that affect the estimated shipping and packaging costs of the product are the packaging thickness, the packaging material type, and the number of packages containing the product that can fit within a shipping container.

What are needed are systems and methods to evaluate the design of a particular shipping item (e.g., either the initial product design or the initial packaging design) and to identify potential modifications of the shipping item design that would reduce shipping costs (e.g., by increasing the density of shipping items within the same shipping container volume).

### SUMMARY

In one aspect, the invention features a machine-implemented method of identifying one or more potential modifications of a shipping item's design. In accordance with this inventive method a first number of homogeneous copies of the shipping item in a first design state that fit on a specified shipping pallet is identified. One or more modifications of the shipping item's design are computed. The computed modifications transform the first design state into a second design state of the shipping item homogeneous copies of which fit on the specified shipping pallet in a second number greater than the first number.

The invention also features systems and machine-readable instructions for implementing the above-described potential modification identification method.

Other features and advantages of the invention will become apparent from the following description, including the drawings and the claims.

### DESCRIPTION OF DRAWINGS

FIG. 1 is a block diagram of an embodiment of a shipping item analysis system receiving specifications of a shipping item in a first design state and presenting optimized shipping parameters for shipping the shipping item in the first design state and potential modifications of the first design state of the shipping item.

FIG. 2 is a flow diagram of an embodiment of a method of identifying potential modifications of a shipping item design.

FIG. 3A is a diagrammatic view of an embodiment of a process of loading a product in a package and loading twenty-seven homogeneous copies of the package on a shipping pallet.

FIG. 3B is a diagrammatic view of the process shown in FIG. 3A applied to a modified version of the product that allows thirty-six homogeneous copies of the package to be loaded on the shipping pallet.

FIG. 4 shows an embodiment of a graphical user interface prompting a user to define parameters of a shipping item analysis job.

FIG. 5 shows an embodiment of a graphical user interface prompting a user to input parameters defining a first design state of a package.

FIGS. 6A-6F show exemplary layouts of single layers of respective sets of homogeneous copies of respective packages on respective shipping pallets.

FIG. 7 shows a graph of linear constraints constraining dimensions of potential design states of a package plotted as a function of package dimensions in a plane parallel to the support surface of a shipping pallet.

FIG. 8 shows two exemplary design states of a package superimposed on the graph shown in FIG. 7.

FIG. 9 shows the graphical user interface of FIG. 5 presenting optimized shipping parameters for shipping the package in the first design state and potential modifications of the first design state of the package.

FIG. 10 shows the graphical user interface of FIG. 9 after a user has defined a second design state of the package by modifying a dimension of the first design state.

FIG. 11 shows the graphical user interface of FIG. 10 presenting optimized shipping parameters for shipping the package in the second design state and potential modifications of the second design state of the package.

FIG. 12 is an embodiment of a graphical user interface presenting a graph comparing estimates of the results of shipping the package in the design states defined in the graphical user interface of FIG. 11.

FIG. 13 shows an embodiment of a graphical user interface prompting a user to define parameters of a shipping item analysis job.

FIG. 14 shows an embodiment of a graphical user interface prompting a user to input parameters defining a first design state of a product.

FIG. 15 shows the graphical user interface of FIG. 14 presenting optimized shipping parameters for shipping the product in the first design state and potential modifications of the first design state of the product.

FIG. 16 shows the graphical user interface of FIG. 15 after a user has defined a second design state of the product by modifying a dimension of the first design state.

FIG. 17 shows the graphical user interface of FIG. 16 presenting optimized shipping parameters for shipping the product in the second design state and potential modifications of the second design state of the product.

FIG. 18 is an embodiment of a graphical user interface presenting a graph comparing estimates of the results of shipping the product in the design states defined in the graphical user interface of FIG. 17.

### DETAILED DESCRIPTION

In the following description, like reference numbers are used to identify like elements. Furthermore, the drawings are intended to illustrate major features of exemplary embodiments in a diagrammatic manner. The drawings are not intended to depict every feature of actual embodiments nor relative dimensions of the depicted elements, and are not drawn to scale.

I. Introduction

The embodiments that are described in detail below provide systems and methods of evaluating the design of a particular shipping item (e.g., either the initial product design or the initial packaging design) and identifying potential modifications of the shipping item design that would reduce shipping costs or packaging costs at an early stage in the design process (e.g., by increasing the density of shipping items within the same shipping container volume or by reducing the amount of packaging material required). Some embodiments are capable of evaluating the cost impact of a wide variety of different shipping item parameters, including size, weight, robustness, accessory location, and shipping orientation of a product, and thickness and material type of the packaging for the product. These embodiments also are able to identify specific modifications of a shipping item design. In addition, these embodiments compute estimates of the freight and packaging costs for both the original design and the modified designs, as well as the estimated cost savings associated with the modified designs. In this way, these embodiments enable product engineers and packaging engineers to jointly identify cost-effective product and packaging designs that reduce shipping and packaging costs.

As used herein the term “shipping item” refers to any type of item that is shipped, including a product within a package and a package containing a product.

As used herein the term “package” refers to the container that holds a product, including any accessories. The terms “package” and “box” are used interchangeably herein. The term “packaging” refers to all of the components of the package, including any cushion material within the container but excluding the product and any accessories associated with the product.

The term “design state” refers to the physical aspects of a shipping item that impact the layout of the shipping item on a pallet and the costs of shipping the shipping item or the cost of the packaging material. The design state of a shipping item may be specified by a set of parameters that relate to, for example, size, weight, robustness, accessory location, type of cushion material, physical tolerances, and shipping orientation of a shipping item.

The term “scenario” refers to a set of parameters associated with a shipping item design state, including input parameters that define the design state and parameters that are derived from the input parameters (e.g., parameters for evaluating the design state in terms of transport quality and shipping costs, and parameters that define potential modifications to the design state).

II. Overview of Shipping Item Analysis System

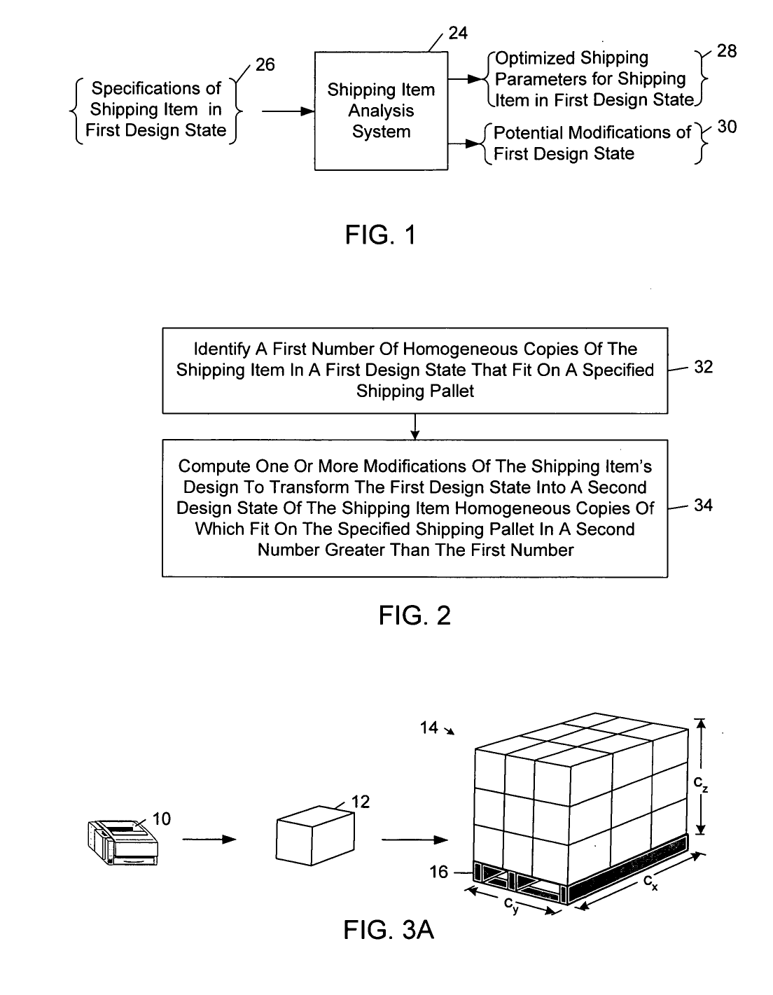

FIG. 1 shows an embodiment of a shipping item analysis system 24 receiving specifications 26 of a shipping item in a first design state and presenting optimized shipping parameters 28 for shipping the shipping item in the first design state and potential modifications 30 of the first design state of the shipping item. The shipping item analysis system 24 may be implemented in any computing or processing environment, including in digital electronic circuitry or in computer hardware, firmware, or software. In some embodiments, the shipping item analysis system 24 is implemented by one or more software modules that are executed on a computer. In one embodiment, the product portfolio analyzer 32 may be implemented as a Microsoft® Excel utilizing Visual Basic® for Applications (VBA) computer program operable as a spreadsheet tool, which is operable on a personal computer or a workstation. Computer process instructions for implementing the shipping item analysis system 24 and the data generated by the shipping item analysis system 24 are stored in one or more machine-readable media. Storage devices suitable for tangibly embodying these instructions and data include all forms of non-volatile memory, including, for example, semiconductor memory devices, such as EPROM, EEPROM, and flash memory devices, magnetic disks such as internal hard disks and removable disks, magneto-optical disks, and CD-ROM.

FIG. 2 shows a flow diagram of an embodiment of a method of identifying potential modifications of a shipping item design that is implemented by an embodiment of the shipping item analysis system 24. In accordance with this embodiment, a first number of homogeneous copies of a shipping item in a first design state that fit on a specified shipping pallet is identified (FIG. 2, block 32). One or more modifications of the shipping item's design are computed (FIG. 2, block 34). The computed modifications transform the shipping item from the first design state to a second design state homogeneous copies of which fit on the specified shipping pallet in a second number greater than the first number.

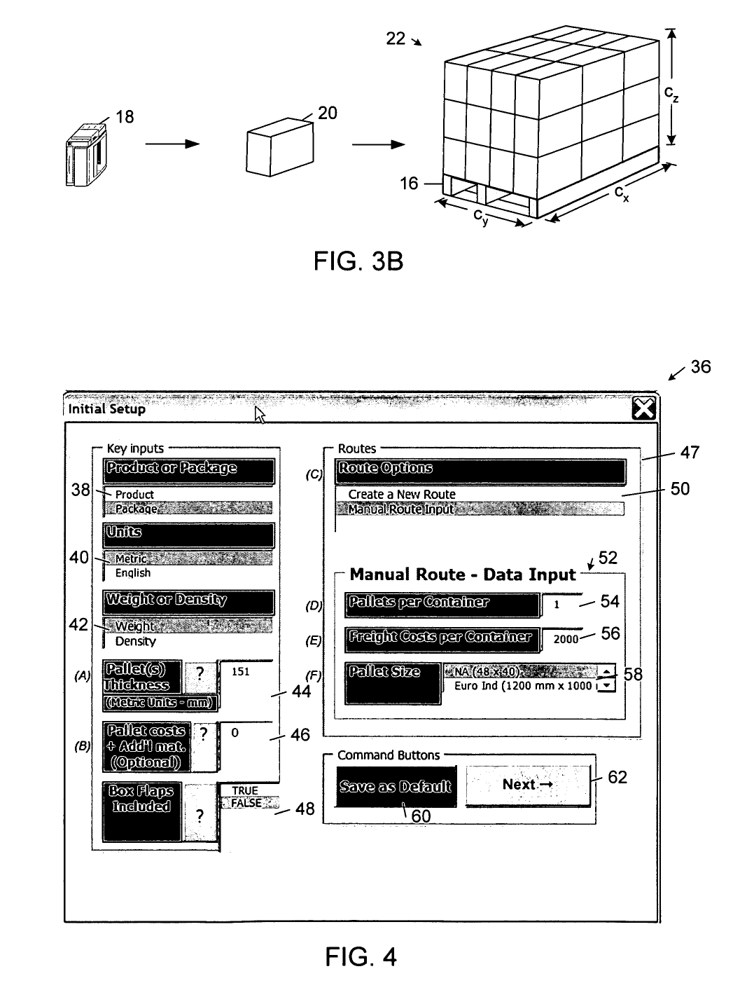

For example, FIG. 3A shows a diagrammatic view of an embodiment of a process of loading a product 10 (e.g., a laser printer) in a package 12 and loading twenty-seven homogeneous copies 14 of the package 12 on a shipping pallet 16. The product 10 corresponds to the first design state of the product. Among the specifications 26 of the first design state of the product 10 that the shipping item analysis system 24 may receive are the size, weight, robustness, accessory location, and shipping orientation of the product 10. The shipping item analysis system 24 also may receive specifications of the thickness and material type of the packaging for the product 10 and dimensional fit tolerances. Based on the received information, the shipping item analysis system 24 determines the dimensions of the package 12 and an optimal layout of the homogeneous copies 14 of the package 12 that will fit on the pallet 16. The number of packages that can be loaded on the shipping pallet 16 typically is constrained by a specified pallet area, with dimensions cₓ×c_{y}, and a specified shipping container height, c_{z}. The shipping item analysis system 24 presents optimized shipping parameters 28 for shipping the product 10 in the first design state and potential modifications 30 of the first design state of the product 10. Among the optimized shipping parameters 28 that the shipping item analysis system 24 presents are the dimensions of the package 12, the number of copies 14 of the package 12 that can be shipped on each shipping pallet 16, and the packaging and transport costs associated with shipping the product 10 in the first design state. Among the potential modifications 30 of the first design state that the shipping item analysis system 24 presents are specific modifications of one or more dimensions of the product 10 that would allow a larger number of copies of the product 10 to be shipped on the shipping pallet 16.

FIG. 3B shows a diagrammatic view of the process shown in FIG. 3A that is applied to a product 18, which corresponds to a version of the product 10 that is modified in accordance with one or more of the modifications 30 that are presented by the shipping item analysis system 24. In particular, the product 18 has properties (e.g., size, weight, robustness, accessory location, shipping orientation) that allow it to be loaded into a package 20 that is sufficiently smaller than the package 12 that thirty-six homogeneous copies 22 of the package 20 can be loaded on the shipping pallet 16 within the shipping volume cₓ×c_{y}×c_{z}. In many cases, shipping companies charge a fixed fee for each shipping container or shipping pallet that is shipped. In these cases, the design of product 18 is superior to the design of product 10 in terms of shipping cost per unit because nine more packages can be shipped on each shipping pallet 16.

III. Exemplary Graphical User Interface for the Shipping Item Analysis System

A. Initial Setup, of a Shipping Item Analysis Job

FIG. 4 shows an embodiment of a graphical user interface 36 that includes the following fields, which prompt a user to define various parameters of a shipping item analysis job:
A Product or Package input field 38 allows a user to specify a Product analysis job or a Package analysis job. In a Product analysis job, the shipping item analysis system 24 calculates package dimensions based on a specified set of product and accessory dimensions and on a calculated thickness of cushion material that meets the specified robustness constraints of the product. In a Package analysis job, the shipping item analysis system 24 calculates product dimensions using package size as a constraint.
A Units input field 40 allows the user to specify whether the inputs and outputs are presented in metric (e.g., mm and kg) units or in English (e.g., inches and lbs) units.
A Weight or Density input field 42 allows the user to specify whether certain package dimensions will be input in terms of weight or density. If the user selects Weight, the shipping item analysis system 24 will prompt the user to enter the approximate weight of the product. If the user selects density, the shipping item analysis system 24 will estimate the product weight based on the specified size and density of the product.
A Pallet(s) Thickness field 44 prompts the user to enter the thickness of the pallet or slip sheet used to stack packages. If pallets are going to be stacked, the user should enter the result of multiplying a single pallet thickness by the number of pallets to be stacked.
A Pallet Costs+Add'l mat. input field 46 allows the user to enter any additional costs per pallet not included in the cost data associated with the routes selected in the Routes section 47 of the graphical user interface 36 or with the cost of the packaging material.
A Box Flaps Included input field 48 prompts the user to specify whether the shipping item analysis system 24 should include box flap thickness in its calculations. If the user selects the TRUE option, the shipping item analysis system 24 doubles the box thickness in calculations relating to the top and bottom of the package relative to the support surface of the pallet, where the bottom of the package contacts the support surface of the pallet and the top of the package is opposite the package bottom. If the user selects the FALSE option, the shipping item analysis system 24 assumes a single box thickness on all sides of the package in its calculations. In some embodiments, the user is prompted to select the orientation of the box flaps.
A Route Options field 50 allows a user to select a Create a New Route option or a Manual Route Input option. The Create a New Route option allows a user to add a standard route that may be re-used. The Manual Route Input option allows a user to bypass system presets of previously defined routes. The selection of the Manual Route Input option will active the Manual Route—Data Input area 52, which allows the user to specify Pallets per Container 54, Freight Costs per Container 56, and a Pallet Size 58 from a list of preset pallet sizes.

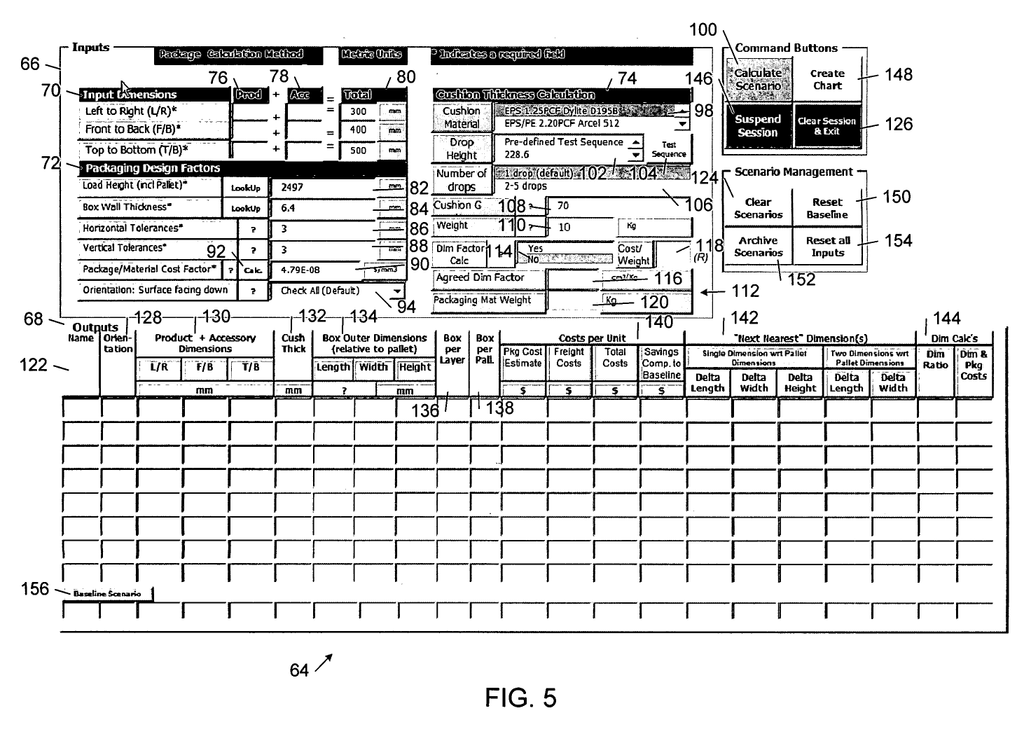

The graphical user interface 36 includes a Save Defaults button 60 that allows the user to save the current settings as the default, so that they will not have to be re-entered the next time the shipping item analysis system 24 is used. The Next button 60 causes the shipping item analysis system 24 to switch to an Inputs and Outputs graphical user interface 64 (shown in FIG. 5 and described in the next section), which contains more detailed inputs and presents output data for different scenarios.

B. Receiving Inputs Defining a Shipping Item Analysis Job

FIG. 5 shows an embodiment of a graphical user interface 64 that includes an Inputs section 66 and an Outputs section 68. The Inputs section 66 includes an Input Dimensions area 70, a Packaging Design Factors area 72, and a Cushion Thickness Calculation area 74. The properties of at least some of the input fields that are displayed in the Inputs section 66 depend on the selections that were made in the graphical user interface 36. The state of the graphical user interface 64 shown in FIG. 5 corresponds to the following initial setup selections: Package in the Product or Package field 38; Metric in the Units field 40; and Weight in the Weight or Density field 42.

The Input Dimensions area 70 includes dimension fields 76 for an initial state of a product, dimension fields 78 for any associated accessories that will be packaged with the product, and dimension fields 80 for the total dimensions of the package. In the illustrated embodiments, the Left to Right (L/R) dimension corresponds to the length of the product, the Front to Back (F/B) dimension corresponds to the width of the product, and the Top to Bottom (T/B) dimension corresponds to the height of the product.

If Product is selected in the initial setup graphical user interface 36, only the product dimension fields 76 and the accessory dimension fields 78 are editable. In this mode of operation, the total package dimension fields 80 are not editable; they are calculated by the shipping item analysis system 24 based on the inputs entered in the product dimension fields 76 and the accessory dimension fields 78. If Package is selected in the initial setup graphical user interface 36, only the total package dimension fields 80 are editable; the product dimension fields 76 and the accessory dimension fields 78 are not editable, as shown in FIG. 5. In this mode of operation, the shipping item analysis system 24 calculates the packaging requirements based on product weight and other characteristics, and displays in the Product+Accessory Dimensions fields 130 of the Outputs section 68 dimension constraints that the product must meet in order to fit into the is package dimensions specified in the total dimension fields 80. In this process, the shipping item analysis system 24 works from a given box size inward to calculate the combined product and accessory values (e.g., dimensions, product robustness, etc.).

The Packaging Design Factors area 72 allows the user to specify various parameters relating to the design of the packaging.
A Load Height field 82 allows the user to enter the maximum height that a loaded pallet can attain. This height typically is constrained by the size of the door or aperture through which the pallet must enter the trailer or container. The load height typically is the smaller of the size of the door and the size of the maximum load as constrained by the number of units that can be stacked.
A Box Wall Thickness field 84 prompts the user to enter the thickness of the corrugated box used. Note that if the Flaps option was set to TRUE in the initial setup graphical user interface 36, the box will always be oriented on the pallet such that the flaps will be on the top and the bottom, regardless of the product orientation chosen. In some embodiments, the box is oriented in accordance with the user's specification of the orientation of the box flaps with respect to the pallet. If the Flaps option was set to FALSE, then single box thickness will be assumed for all sides of the box.
A Horizontal Tolerances field 86 prompts the user to enter the amount of empty space (horizontal) that must be included along with the product and the packaging in order to correctly calculate the number of units that will accurately fit onto a pallet. This includes both box-cushion tolerance, and cushion-product tolerance.
A Vertical Tolerances field 88 prompts the user to enter the amount of vertical tolerance required. Note that vertical tolerance allows entry of a negative number, to accommodate cases where heavy products may actually compress the packaging a bit. This includes both box-cushion tolerance, and cushion-product tolerance.
A Package Material Cost Factor field 90 prompts the user to enter an estimate of the future material cost per box volume for the packaging material used (e.g., $/mm³ or $/in³). Data from a previous comparable product of similar size that uses the same cushion material may be used to determine this estimate. The user may select a Calc button 92 for help in calculating this estimate.
An Orientation field 94 allows the user to specify how the product inside the box is oriented on the pallet relative to the “standard” orientation of the product. The standard orientation of a printer, for example, is bottom down, paper tray facing the front of the package. The user may select the surface that faces down from a list presented in a pull down menu 96, or the user may select the default option of “Check All” orientations to have the shipping item analysis system 24 calculate outputs for all possible orientations. The options presented in the pull down menu 96 are: Check all orientations; T/B- calculate for a top-bottom orientation only (i.e., product is upright); L/R- calculate for a left-right orientation only (i.e., product is on its side, with either left or right side on the bottom); and F/B -calculate for a front-back orientation only (i.e., product is tipped on its face or on its back, so either the front or back is at the bottom).

The Cushion Thickness Calculation area 74 allows the user to specify various aspects affecting the thickness of the cushion material in the package. In a normal mode of operation, the shipping item analysis system 24 calculates the required thickness of the cushion material based on the product weight, fragility, drop height, number of drops, and cushion type. Cushion thickness is calculated using material property equations in the form y=Ae^{Bx} according to the stress/energy method described by Burgess for each cushion material (see, e.g., Gary Burgess, “Consolidation of Cushion Curves,” Journal of Packaging Technology and Science (Jun. 1, 1990)). The user, however, is presented with an option to override this calculation. The Cushion Thickness Calculation area 74 includes the following fields:
A Cushion Material field 98 allows the user to choose from a list of pre-defined cushion materials. To bypass the cushion thickness calculation, the user may select the listed option “Manually input cushion thickness”. The user may elect this option, for example, if the user is using a cushion type that is not in the list or if the user is doing some what-if analysis and wants to assess costs for a given cushion thickness. In this mode of operation, a separate input dialog box that prompts the user to enter the cushion thickness is not displayed until the user selects the Calculate Scenario button 100.
A Drop Height field 102 allows the user to enter the height from which a packaged product must be able to be dropped without breakage. The height is either in inches or millimeters, depending on whether the user selected English or Metric units in the initial setup graphical user interface 36. The options presented in the Drop Height field 102 are based on industry standards. It is also possible to use a pre-defined sequence selecting suggested drop heights for different product weights. The user may specify such a pre-defined sequence by selecting the Test Sequence button 104.
A Number of Drops field 106 prompts the user to enter the number of drops from the height specified in the Drop Height field 102 that the packaged product must be able to survive without breakage. In the illustrated embodiment, the user may select the Number of Drops from the following pre-set options: 1 drop; and 2-5 drops.
A Cushion G field 108 prompts the user to define the design robustness of the product as obtained from product engineering in terms of the G level that is transmitted through the package to the product in free-fall drop. The lower this number, the more fragile the product.
A Weight field 110 prompts the user to enter the weight of the product and accessories, in pounds (English units) or kilograms (metric units). The Inputs section 66 of the graphical user interface 64 additionally includes a Dim factor inputs area 112 that allows the user to specify volume-based surcharges that apply to a particular shipment. In particular, full truck load shipments typically are charged are by volume only. Therefore, box size is the cost-determining factor, with smaller sizes being lower in cost. But in some cases, such as where the initial product is shipped by air or padded truck, additional freight charges may apply. These charges may depend on both weight and volume. In these cases, freight is charged based on a Dim Weight calculation. Dim Weight is defined as (Package Length×Width×Depth)/Dim Factor. Dim Factor is a negotiated number with the freight supplier and is entered into field 116. The Dim Ratio is then calculated by the equation Dim Weight/Actual Weight. If Dim Ratio is greater than 1, extra freight surcharges are applied. If Dim Ratio is less than 1, freight is paid based on actual package weight. The Dim fact inputs area 112 includes the following fields:
A Dim Factor Calc field 114 prompts the user to select Yes if Dim Weight (and hence Dim Ratio) are to be calculated. This will activate the following related fields. If the user selects No, the following related fields are not activated.
An Agreed Dim Factor field 116 prompts the user to enter the negotiated or target Dim Factor in cm³/kg.
A Cost/Weight field 118 prompts the user to enter the negotiated Cost/Weight in $/Kg or $/lb (depending on the initial unit selection).
A Package Mat Weight field 120 prompts the user to enter an estimate of the package weight, which is used by the shipping item analysis system 24 in the Dim factor calculation.

C. Presenting Outputs for a Shipping Item Analysis Job

The Outputs section 68 of the graphical user interface 64 presents the calculated comparisons between various packaging options, including a running summary of the most recently calculated scenarios, along with the baseline scenario. The Outputs section 68 includes the following output fields:
A Name field 122 includes a name that the shipping item analysis system 24 automatically assigns to each scenario. In the illustrated embodiment, the names are numbered consecutively (e.g., “Opt 1”, “Opt 2”, . . . ), with the highest numbered (most recent) scenarios at the top. This list grows until the user selects the Clear Scenarios command button 124 or the Clear Session and Exit command button 126.
An Orientation field 128 identifies the orientation (i.e., front-back, top-bottom, or left-right) of the shipping item.
The Product & Accessory Dimensions output fields 130 are dependent on whether the user selected “Product” or “Package” in the Initial Setup graphical user interface 36. If the user selected Product, the fields 130 will show the input values supplied in the Input Dimensions area 70. If the user selected Package, the fields 130 will show product dimensions calculated based on the specified package dimensions, the specified package thickness, the specific horizontal and vertical tolerances, and the calculated or specified cushion material thickness.
A Cush Thick field 132 shows the calculated or manually-entered cushion thickness.
The Box Outer Dimensions (relative to pallet) fields 134 show the total package size, which is either calculated by the shipping item analysis system 24 or input by the user, depending on whether the user selected “Product” or “Package” in the Initial Setup graphical user interface 36.

If the user selected Product, the Box Outer Dimensions fields 134 will show the calculated values of the total package, based on input product dimensions.

If the user selected Package, the Box Outer Dimensions fields 134 will show the package dimensions values supplied from the “Total” column under “Input Dimensions”. As used herein, the “pallet width” is the longer of the two dimensions of the pallet support surface, whereas the “pallet length” is the shorter of these two dimensions. For example, the width of a 48×40 pallet is 48 and the length is 40. The specified product and accessory dimensions are treated as constants by the shipping item analysis system 24. However, the outer dimensions of the packages that are computed by the shipping item analysis system 24 that are presented in the Box Outer Dimensions fields 134 will vary depending on the orientation of the product within the package as follows:

TABLE 1

| If product | |
|---|---|
| orientation is | Then . . . |
| T/B | Box Length is for Product's L/R dimension |
| | Box Width is for Product's F/B dimension |
| | Box Height is for Product's T/B dimension |
| L/R | Box Length is for Product's T/B dimension |
| | Box Width is for Product's F/B dimension |
| | Box Height is for Product's L/R dimension |
| F/B | Box Length is for Product's L/R dimension |
| | Box Width is for Product's T/B dimension |
| | Box Height is for Product's F/B dimension |

A box per layer field 136 shows the total number of packaged units that can fit onto a single pallet layer. This number is calculated using stored pallet configuration layout patterns based on pallet dimentions.
A Box per Pall field 138 shows the total number of packaged units that can fit onto a single pallet. This output number is influenced by the type of pallet and the specified load height.
The Costs per Unit fields 140 show the following cost-related estimates for each of the scenarios:
   The Pkg Cost Est. per Unit is the estimated per-unit packaging cost, which is given by:
      (Volume of packaging material)×(Packaging material cost/volume) (1)
   The Unit Freight Costs are the estimated per-unit freight cost, which is given by:
      (Total costs per route)/(Units per container) (2)
   The Total Costs per Unit is the sum of per-unit packaging and freight costs.
   The Savings Comp to Baseline field shows the per unit savings (or lack thereof) compared with the scenario that the user has designated as the “baseline” in terms of the values in Total Costs estimates. A positive number indicates savings, whereas a negative number indicates a cost increase.
The Next Nearest Dimensions fields 142 show the product/box size reduction (in inches or millimeters) that are required to fit more units on a pallet. If this is a very small number in relation to the shipping item size, this provides an easy way to spot new potential savings. Two types of output are presented in these fields 142:
   Single dimension: proposing reductions in the product size along one axis only.
   Two dimensions: proposing reductions in the product size along two dimensions—this is given if a solution combining reductions along two axes exists where the reduction along any single axis is less than that found for the single axis analysis.
The Dim Calc's fields 144 include a Dim Ratio field and a Dim & Pkg Costs field. A number greater than one in the Dim Ratio field indicates that a volume-based surcharge may be incurred for additional shipments (e.g., air freight). The Dim & Pkg Costs field shows the cost per unit shipped for weight-based shipments, including any Dim factor penalty and packaging costs. The “Dim Factor” output may be used as a flag to identify when additional costs will be incurred. This output shows the volume to weight ratio. A Dim Ratio of less than one is good, and means the user is only paying by weight. If the Dim Ratio is over one, it means that the user is paying for volume and weight. The total Dim & Packaging cost estimates the cost for weight-based freight subject to the dim factor.

D. Command Buttons

The graphical user interface 64 also includes the following command buttons:
The Calculate Scenario button 100 triggers the calculation of a new scenario (or set of scenarios) based on the currently displayed input values.
The Suspend Session button 146 allows the user to view the raw data on the spreadsheet without exiting the shipping item analysis system 24.
The Create Chart button 148 triggers the creation of a chart containing one or more of the currently displayed scenarios. The user may specify whether the system 24 should include all the scenarios in the chart or only a specified number of “best” scenarios.
The Clear Session and Exit button 126 causes the system 24 to clear the Outputs section 68 and exits the shipping item analysis system 24.
The Clear Scenarios button 124 causes the system 24 to clear the Outputs section 68 without exiting the shipping item analysis system 24.
The Reset Baseline button 150 causes the system 24 to remove the “baseline” designation. Note that it does not select a new baseline; to do that, the user must click the Calculate Scenario button 100 and indicate which scenario will serve as the baseline.
The Archive Scenarios button 152 is used this to copy calculated scenario data to an archive location. Each archive is labeled with the date and time that the archive was made.
The Reset All Inputs button 154 causes the system 24 to reset all input fields in the Inputs area 70 to their default values.
   IV. Calculating Optimal Layouts of Packages on a Pallet

The Box per Layer, Box per Pall, Costs per Unit, and Next Nearest Dimension(s) output fields are calculated with respect to an optimal layout of homogeneous copies of a calculated or specified package on a pallet of the type specified in the Initial Setup graphical user interface 36. In the package analysis mode of operation, the specified package has outer dimensions that are specified in the Total input field 80 of the Input section 66 of the graphical user interface 64. In the product analysis mode of operation, the outer dimensions of the package are calculated by the shipping item analysis system 24 as described above. The shipping item analysis system 24 identifies the optimal pallet layout for a package on a specified pallet by first determining the number of packages that can fit on a single pallet layer and then determining the number of layers of packages that will fit within the load height value specified in the Load Height Field in the Packaging Design Factors area 72.

The shipping item analysis system 24 determines the number of packages that can fit on a single pallet layer by identifying at least one pallet layout in a set of predefined pallet layouts that can accommodate the horizontal (i.e., parallel to the pallet support surface) dimensions of the packages within the bounds defined by the dimensions of the pallet support surface. The set of predefined pallet layouts corresponds to a plurality of possible arrangements of packages in a single layer on a pallet.

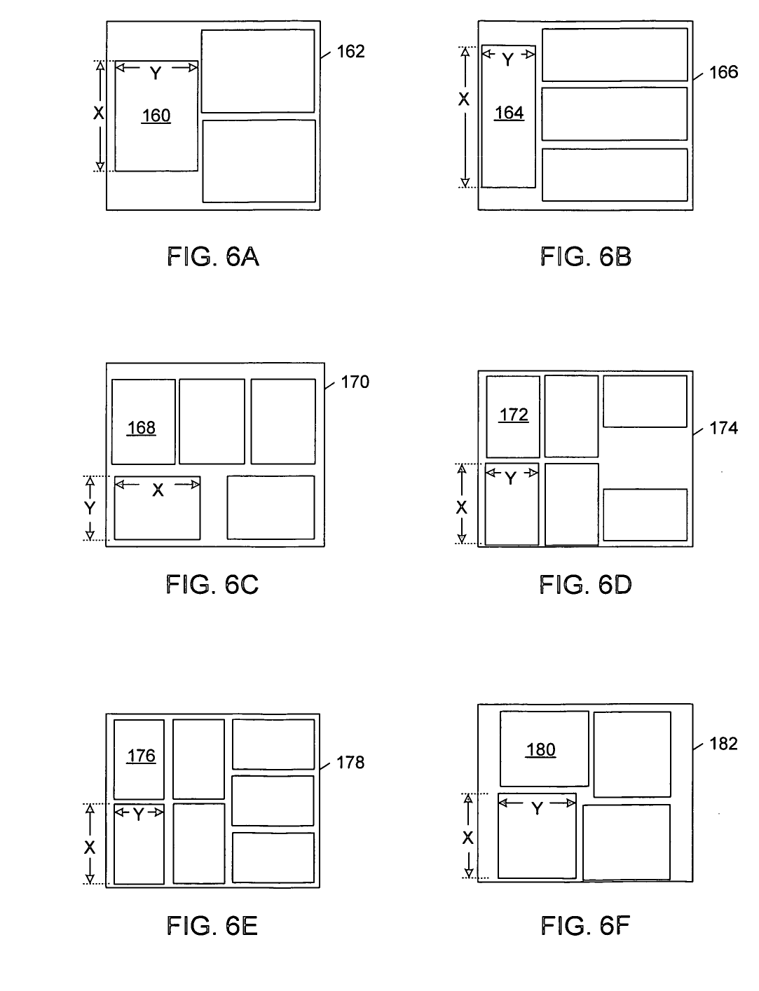

FIGS. 6A-6F respectively show six of many different possible arrangements of respective sets of homogeneous packages arranged in single layers on respective pallets. FIG. 6A shows an arrangement of three homogeneous packages 160 on a pallet 162. FIG. 6B shows an arrangement of four homogeneous packages 164 on a pallet 166. FIG. 6C shows an arrangement of five homogeneous packages 168 on a pallet 170. FIG. 6D shows an arrangement of six homogeneous packages 172 on a pallet 174. FIG. 6E shows an arrangement of seven homogeneous packages 176 on a pallet 178. FIG. 76 shows an arrangement of four homogeneous packages 180 on a pallet 182.

In some embodiments, the pallet layout identification process is simplified by translating each pallet layout into a respective set of linear constraints defined by variable parameters that correspond to the dimensions of the pallet support surface and the dimensions of the package parallel to the pallet support surface. In these embodiments, each pallet layout is translated into a respective set of linear equations that constrain the dimensions of the package with respect to the dimensions of the pallet. In the following discussion, the variable X represents the longest box dimension parallel to the pallet support surface, the variable Y represents the shortest box dimension parallel to the pallet support surface, cₓ, represents the longest dimension of the support surface of the specified pallet, and c_{y} represents the shortest dimension of the support surface of the specified pallet. In the following analysis it is assumed that the specified box dimensions accommodate box packing tolerances (i.e., the actual box dimensions are smaller than the box dimensions specified by the user or calculated by the shipping item analysis system 24).

As shown, for example, in FIGS. 6A-6F, each pallet layout includes an integer multiple of X and an integer multiple of Y arranged along a respective dimension of the pallet, where the multiplicative factors take on integer values greater than or equal to zero. Thus, in the general case, each pallet layout may be translated into the following set of linear constraints:
aᵢₓX+bᵢₓY≦cₓ (3)
a_{iy}X+b_{iy}Y≦c_{y} (4)
where aᵢₓ is the number of the longest box dimension in box row i along the longest dimension of the pallet, bᵢₓ is the number of the shortest box dimension in box row i along the longest dimension of the pallet, a_{iy} is the number of the longest box dimension in box column i along the shortest dimension of the pallet, and b_{iy} is the number of the shortest box dimension in box column i along the shortest dimension of the pallet.

For example, the pallet layout shown in FIG. 6A is translated into the following set of constraints in accordance with equations (3) and (4):
X+Y≦cₓ (5)
2Y≦c_{y} (6)
X≦c_{y} (7)
The pallet layout shown in FIG. 6B is translated into the following set of constraints in accordance with equations (3) and (4):
X+Y≦cₓ (8)
3Y≦c_{y} (9)
X≦c_{y} (10)
The pallet layout shown in FIG. 6C is translated into the following set of constraints in accordance with equations (3) and (4):
3Y≦cₓ (11)
X+Y≦c_{y} (12)
2X≦cₓ (13)
The pallet layout shown in FIG. 6D is translated into the following set of constraints in accordance with equations (3) and (4):
X+2Y≦cₓ (14)
2X≦c_{y} (15)
2Y≦c_{y} (16)
The pallet layout shown in FIG. 6E is translated into the following set of constraints in accordance with equations (3) and (4):
X+2Y≦cₓ (17)
2X≦c_{y} (18)
3Y≦c_{y} (19)
The pallet layout shown in FIG. 6F is translated into the following set of constraints in accordance with equations (3) and (4):
X+Y≦cₓ (20)
X+Y≦c_{y} (21)

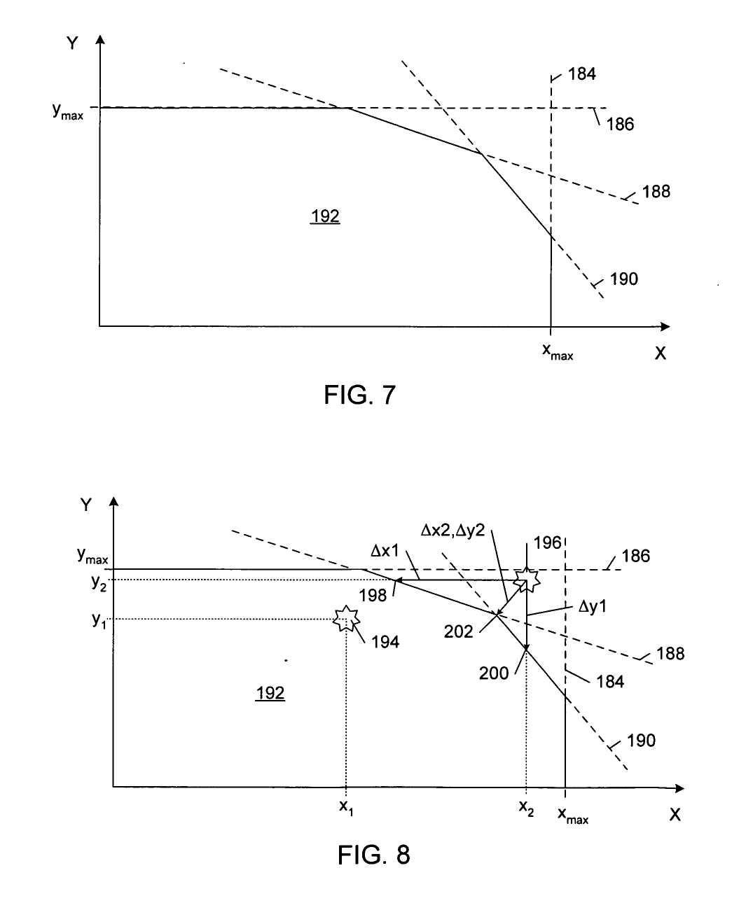

FIG. 7 shows a graph in which an exemplary set of linear constraints are depicted by dashed lines 184, 186, 188, 190. The lines 184 and 186 are of form defined by equations (3) and (4) with zero multiplicative factors for Y and X, respectively, whereas the lines 188 and 190 are of the form defined by equations (3) and (4) with non-zero X and Y multiplicative factors. The area 192 corresponds to the space of permitted package dimensions X and Y that will fit on the pallet with dimensions cₓ and c_{y}, The shipping item analysis system 24 identifies whether a particular package will fit on a specified pallet in accordance with a given pallet layout by determining whether the dimensions of the particular package satisfy the linear constraints associated with the specified pallet layout.

In some embodiments, the shipping item analysis system 24 evaluates the set of linear constraints in order of pallet layout ranked by the numbers of shipping items in the pallet layouts. The shipping item analysis system 24 selects the highest ranked pallet layout whose constraints are satisfied as the optimal pallet layout for the shipping item.

V. Determining Next Nearest Dimensions

FIG. 8 shows graphical representations of two design states 194, 196 of a package superimposed on the graph shown in FIG. 7. The first design state 194 is located within the permitted area 192 (i.e., the dimensions of the package in the first design state 194 satisfy the linear constraints shown in FIG. 8). Therefore, homogeneous copies of the package in the first design state 194 can be laid out on the specified pallet in accordance with the pallet layout defined by the linear constraints shown in FIG. 8. The second design state 196, on the other hand, is not located within the permitted area 192 (i.e., the dimensions of the package in the first design state 194 do not satisfy the linear constraints shown in FIG. 8). Therefore, homogeneous copies of the package in the second design state 196 cannot be laid out on the specified pallet in accordance with the pallet layout defined by the linear constraints shown in FIG. 8.

The shipping item analysis system 24 determines the output values that are presented in the Next Nearest Dimension(s) fields 146 (FIG. 6) by determining the reductions in one or two of the dimensions of the package in the second design state 196 that would transform the package from the second design state outside the permitted area 192 to a design state located on the border of the permitted area 192. In the illustrated embodiments, the shipping item analysis system 24 determines the shortest of the possible one-dimensional design changes (i.e., only the X-dimension can change or only the Y-dimension can change) and the two-dimensional design changes (i.e., both the X-dimension and the Y-dimension can change) that are needed to transform the package into a design state that is located on the border of the permitted area 192. These values can be determined in any of a wide variety of different ways. In the illustrated embodiments, these values are determined using computational geometry algorithms for determining the shortest distance between points and lines.

In the example shown in FIG. 8, the X-dimension of the package in the second design state 196 may be reduced by ΔX1 to transform the package into a design state corresponding to point 198 on the border of the permitted area 192. Alternatively, the Y-dimension of the package in the second design state 196 may be reduced by ΔY1 to transform the package into a design state corresponding to point 200 on the border of the permitted area 192. Both the X-dimension and the Y-dimension of the package in the second design state 196 may be reduced by ΔX2 and ΔY2, respectively, to transform the package into a design state corresponding to point 202 on the border of the permitted area 192.

VI. Identifying Potential Pachage Design Modifications

A. Overview

In general, a user may identify scenarios that have higher transport quantity and savings by reviewing the following output fields:

Box per Pall fields 138
The scenario having the highest box per pallet number typically corresponds to the best design state of the shipping item currently under consideration. This is especially true for full truck load shipments (or any shipments with volume-based costing), in which the more units that can be transported per fixed-price container, the cheaper the per-unit shipping cost.

Savings Comp to Baseline fields 140
The scenario having the highest savings compared to baseline typically corresponds to the best design state of the shipping item currently under consideration. The baseline scenario will show $0.00 in the savings compared to baseline field. A number in parentheses indicates that a scenario is more expensive than the baseline scenario.

Next Nearest Dimension(s) fields 142
This field shows opportunities for reducing one or more box dimensions in order to fit more units onto a pallet. A small next nearest dimension number relative to the specified shipping item dimensions indicates that a small change could yield savings. In the illustrated embodiments, the recommended dimension to be reduced (Height, Width, Length) is identified with respect to it's position on the pallet, where Length is the longer of the two horizontal dimensions parallel to the pallet support surface.

Dim Ratio output field
If the user selected “Yes” in the Dim Factor Calc. input field 114, then a Dim Ratio greater than one indicates that additional freight surcharges for volume are expected to apply with respect to any portion of the product that is shipped by air (or other special shipment) instead of surface. This is relevant if the user expects to pay by weight instead of, or in addition to, volume, including air freight and partial truckloads instead of full loads. Surcharges for volume are expected to apply to any portion of the route in which Dim Factors apply.

Dim & Pkg Costs output field
If the user selected “Yes” in the Dim Factor Calc. field 114 and entered a value in the Cost/Weight field 118, then the value in the Dim+Pkg Costs field will show the estimated weight-based cost including dim factor penalty and packaging costs.

B. Identifying Potential Package Design Modifications

This section describes embodiments of the shipping item analysis system 24 that relate to identifying potential modifications of a package design.

1. Example of an Initial Package Design

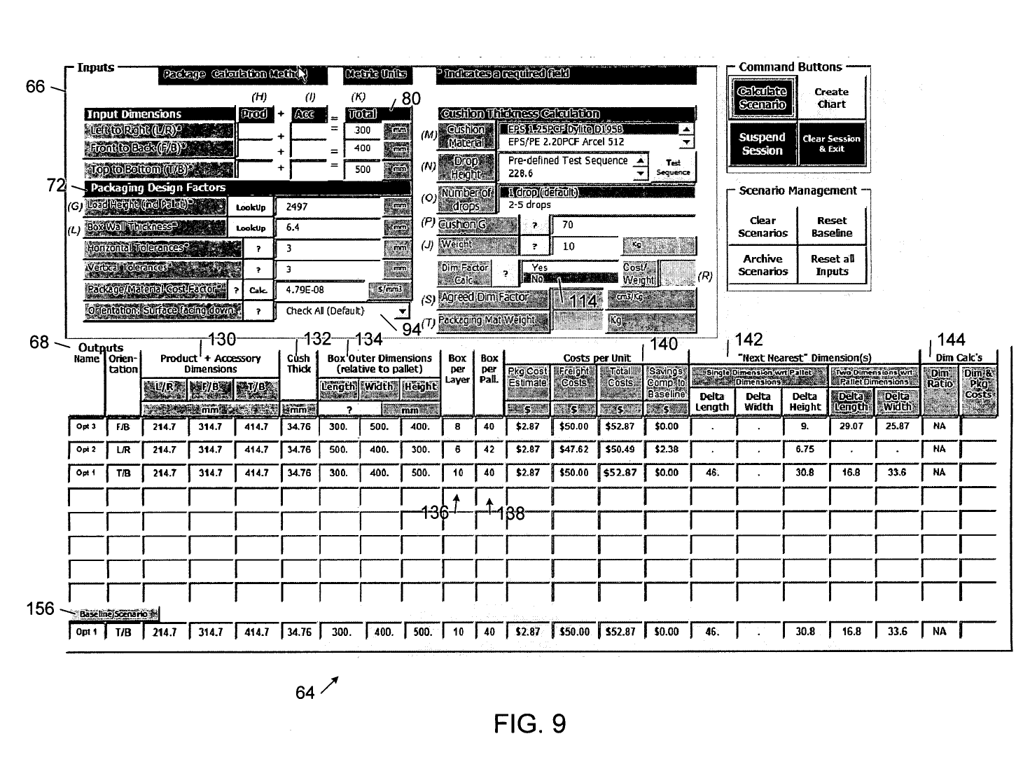

FIG. 9 shows the graphical user interface 64 in a package calculation mode of operation, which is set by selecting the Package option in the Product or Package field 38 of the Initial Setup graphical user interface 36 (FIG. 4). In FIG. 6, the graphical user interface 62 includes exemplary input values that define an initial package design. In particular, the Inputs area 66 contains field values that define an initial state of a package, which has an L/R dimension of 300 mm, an F/B dimension of 400 mm, and a T/B dimension of 500 mm. The load height (including pallet) is 2497 mm. The box wall thickness is 6.4 mm. The horizontal and vertical tolerances are 3 mm. The package/material cost factor is 4.79×10^{31 8}. The Orientation field 94 specifies that all orientations of the product inside the box should be considered by the system 24. The cushion material is EPS 1.25PCF Dylite D195B. The number of drops is one drop. The cushion G is 70. The weight of the product and accessories is 10 kg. The Dim Factor Calc input field 114 specifies that the system 24 does not need to consider any extra charges for palletized shipments of the product.

2. Examples of Scenarios Produced from the Initial Package Design State

The Outputs area 68 of the graphical user interface 64 shown in FIG. 9 contains a set of output values for each of three scenarios (i.e., Opt1, Opt2, and Opt 3) respectively corresponding to the three different orientations of the package on the pallet. The Box Outer Dimensions fields 134 contain the package dimensions values in the Total fields 80 in the Inputs section 66. The Cush Thick fields 132 contain the cushion thickness that was calculated based on the input values entered in the Cushion Thickness Calculation area 74 of the Inputs sections 66. The Product+Accessory Dimensions fields 130 specify the dimensions of the volume available for the product and any accessories in a box having the outer dimensions shown in the Box Outer Dimensions fields 134. The Product+Accessory Dimensions values are calculated by subtracting the cushion thickness, the specified horizontal and vertical tolerances, and the box wall thicknesses from the specified Box Outer Dimensions values.

The Box per Layer field 136 and the Box per Pall. field 138 contain the total number of boxes that can fit on a single pallet layer and the total number of boxes that can fit on the specified pallet in accordance with an optimal layout of homogeneous copies of a box having the outer dimensions specified in the Box Outer Dimensions fields 134. As shown in FIG. 9, although the second scenario (i.e., Opt2) has a fewer number of boxes per pallet layer than the other scenarios, the second scenario has the largest total number of boxes per pallet because its height dimension allows a larger number of layers to fit on a single pallet than the other scenarios.

The Costs per Units fields 140 show estimated costs per unit for each of the scenarios (i.e., Opt1, Opt2, and Opt3). As shown in FIG. 9, the graphical user interface 64 includes a baseline scenario area 156 that contains the parameters of the scenario (i.e., Opt1) that has been designated by the user as the baseline scenario. The Savings Comp. to Baseline fields show that the third scenario (i.e., Opt3) has no cost advantage over the baseline scenario, whereas the second scenario (i.e., Opt2) has a cost advantage of $2.38 per unit over the baseline scenario.

The Next Nearest Dimensions fields 142 show the product/box size reduction (in inches or millimeters) that are required to fit more units onto a pallet for each scenario. With respect to the first scenario (i.e., Opt1), the total number of packages that can fit on a single pallet can be increased by reducing the package length by 46 mm, reducing the package height by 30.8 mm, or by reducing the package length by 16.8 mm and reducing the package width by 33.6 mm. With respect to the second scenario (i.e., Opt2), the total number of packages that can fit on a single pallet can be increased by reducing the package height by 6.75 mm. With respect to the third scenario (i.e., Opt3), the total number of packages that can fit on a single pallet can be increased by reducing the package height by 9 mm, or by reducing the package length by 29.07 mm and reducing the package width by 25.87 mm.

3. Modifying a Package Design to Reduce Shipping Costs

One of the goals of package design is to fit as many packages as possible onto a pallet. Among the possible modifications of a package design that may increase the number of packages that fit on a pallet are:
Reduce one or more package dimensions.
Changing the package orientation.
Reduce the physical tolerances
Change the cushion material

Referring back to the example shown in FIG. 9, the Outputs section 68 of the graphical user interface 64 shows that the total number of packages that can fit on a single pallet with the package in the third design state (i.e., Opt3) can be increased by reducing the package height by 9 mm, or by reducing the package length by 29.07 mm and reducing the package width by 25.87 mm.

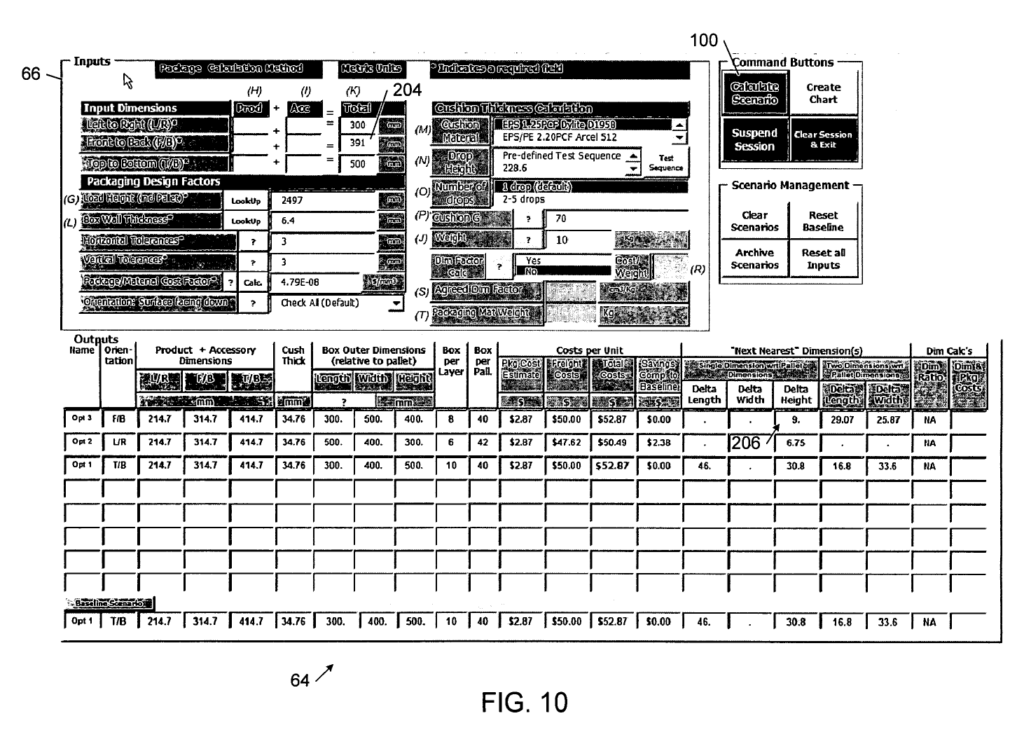

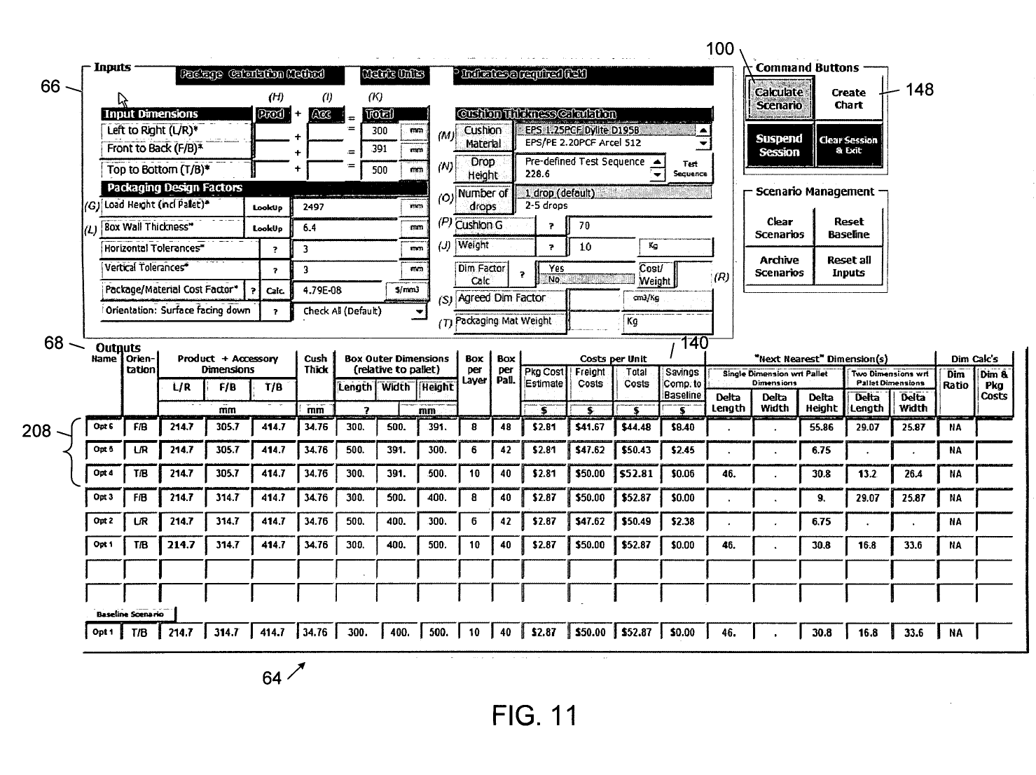

FIG. 10 shows the graphical user interface 64 after the user has transformed the package into a second design state in which the front to back (F/B) dimension 204 is reduced by 9 mm (i.e., from 400 mm to 391 mm) in accordance with the height modification 206 proposed for the third scenario Opt3. (Note: in the package orientation of the third scenario, the next nearest height dimension corresponds to the front to back dimension (i.e., the package width).) FIG. 11 shows the graphical user interface 64 after the user has selected the Calculate Scenario button 100, which causes the shipping item analysis system 24 to calculate new scenarios 208 (i.e., Opt. 4, OptS, and opt6) for the three possible orientations of the second design state of the package on the specified pallet. As shown in the Outputs section 68 of the graphical user interface 64, the sixth scenario (i.e., Opt6) has the largest number (i.e., 48) of boxes per pallet and offers the largest total cost savings per unit (i.e., $8.40) compared to the baseline scenario (i.e., Opt1).

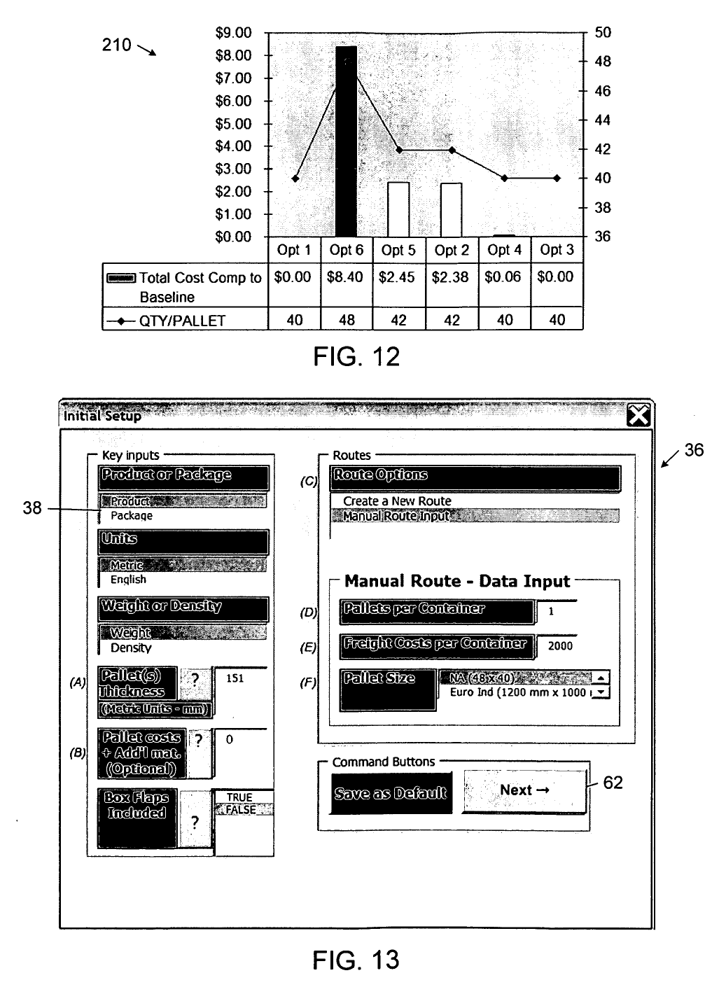

FIG. 12 shows a chart 210 that the shipping item analysis system 24 created in response to the user's selection of the Create Chart button 148 in the graphical user interface 64 shown in FIG. 11. The chart 210 compares the different scenarios in terms of total cost compared to baseline and total number of boxes per pallet. The chart 210 graphically shows that the sixth scenario (i.e., Opt6) is superior to all of the other scenarios in terms of total costs per unit and number of boxes per pallet.

C. Identifying Potential Product Desing Modifications

This section describes embodiments of the shipping item analysis system 24 that relate to identifying potential modifications of a product design. To enter the product calculation mode of operation of the shipping item analysis system 24, the user selects the Product option in the Product or Package field 38 of the Initial Setup graphical user interface 36, as shown in FIG. 13.

1. Example of an Initial Product Design

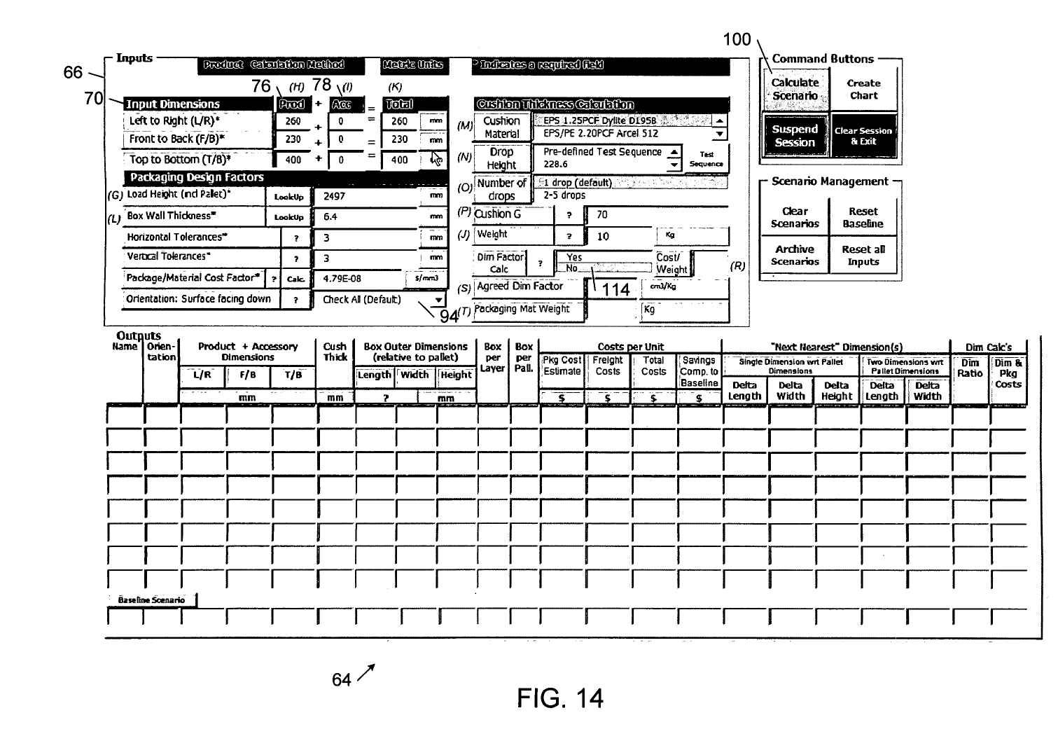

FIG. 14 shows the graphical user interface 64 that is displayed after the user enters values in the Initial Setup graphical user interface 36 shown in FIG. 13 and selects the Next button 62. In the product calculation mode of operation, the product and accessory dimension fields 76, 78 of the Input Dimensions area 70 are activated, allowing the user to specify dimensions for a product and any associated accessories.

In the example shown in FIG. 14, the graphical user interface 62 includes exemplary input values that define an initial product design. In particular, the Inputs area 66 contains field values that define an initial state of a product, which has an L/R dimension of 260 mm, an F/B dimension of 230 mm, and a T/B dimension of 400 mm. All the accessory dimensions are zero. The load height (including pallet) is 2497 mm. The box wall thickness is 6.4 mm. The horizontal and vertical tolerances are 3 mm. The package/material cost factor is 4.79×10⁻⁸. The Orientation field 94 specifies that all orientations of the product inside the box should be considered by the system 24. The cushion material is EPS 1.25PCF Dylite D195B. The number of drops is one drop. The cushion G is 70. The weight of the product and accessories is 10 kg. The Dim Factor Calc input field 114 specifies that the system 24 does not need to consider any extra charges for palletized shipments of the product.

2. Examples of Scenarios Produced from the Initial Product Design State

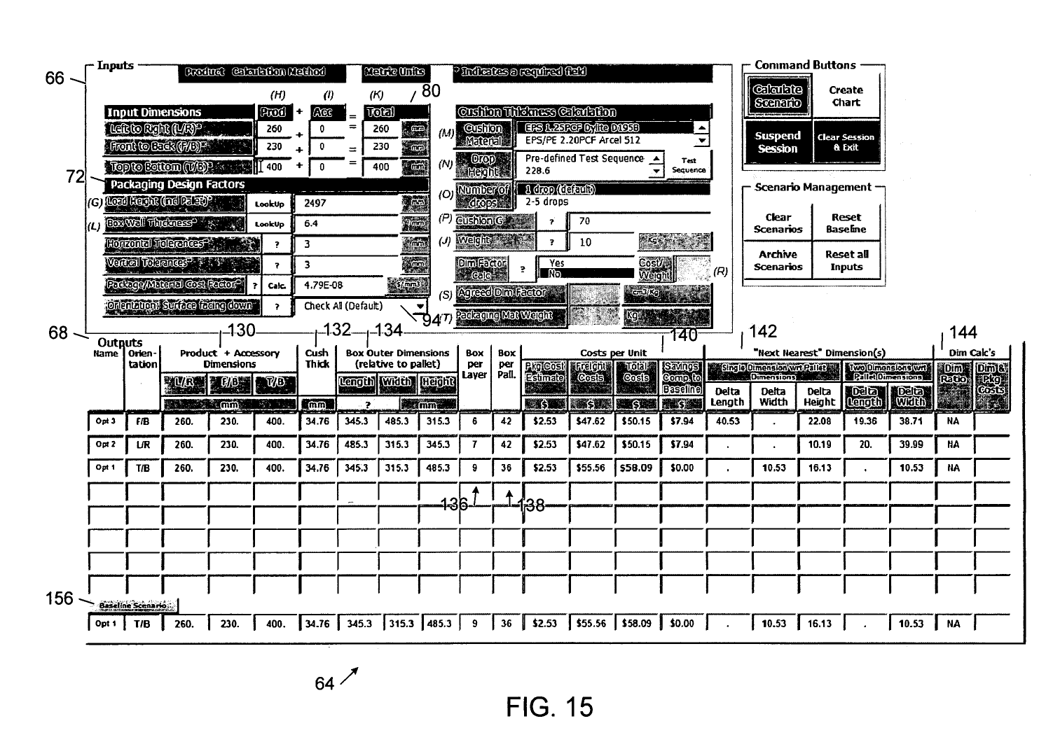

FIG. 15 shows the graphical user interface 64 after the user has entered the values in the Inputs section 66 shown in FIG. 14 and selected the Calculate Scenario command button 100.

The Outputs area 68 of the graphical user interface 64 shown in FIG. 15 contains a set of output values for each of three scenarios (i.e., Opt1, Opt2, and Opt 3) respectively corresponding to the three different orientations of the product on the pallet. The Product+Accessory Dimensions fields 130 contain the dimension values in the Total fields 80 in the Inputs section 66. The Box Outer Dimensions fields 134 contain the package dimensions that are calculated by adding the calculated cushion thickness, the specified horizontal and vertical tolerances, and the box wall thicknesses to the specified total product and accessory dimension values in the Total fields 80. The Cush Thick fields 132 contain the cushion thickness that was calculated based on the input values entered in the Cushion Thickness Calculation area 74 of the Inputs sections 66.

The Box per Layer field 136 and the Box per Pall. field 138 contain the total number of boxes that can fit on a single pallet layer and the total number of boxes that can fit on the specified pallet in accordance with an optimal layout of homogeneous copies of a box having the outer dimensions specified in the Box Outer Dimensions fields 134. As shown in FIG. 15, although the second and third scenarios (i.e., Opt2 and Opt3) have fewer numbers of boxes per pallet layer than the baseline scenario (i.e., Opt1), the second and third scenarios have the largest total numbers of boxes per pallet because their height dimensions allow a larger number of layers to fit on a single pallet than the baseline scenario.

The Costs per Units fields 140 show estimated costs per unit for each of the scenarios (i.e., Opt1, Opt 2, and Opt3). The baseline scenario area 156 contains the parameters of the scenario (i.e., Opt1) that has been designated by the user as the baseline scenario. The Savings Comp. to Baseline fields show that the second and third scenarios (i.e., Opt2 and Opt3) have cost advantages of $7.94 over the baseline scenario.

The Next Nearest Dimensions fields 142 show the product reduction (in inches or millimeters) that are required to fit more units onto a pallet for each scenario. With respect to the first scenario (i.e., Opt1), the total number of packages that can fit on a single pallet can be increased by reducing the product width by 10.53 mm or reducing the product height by 16.13 mm. With respect to the second scenario (i.e., Opt2), the total number of packages that can fit on a single pallet can be increased by reducing the product height by 10.19 mm, or by reducing the product length by 20 mm and reducing the product width by 39.99 mm. With respect to the third scenario (i.e., Opt3), the total number of packages that can fit on a single pallet can be increased by reducing the product length by 40.53 mm, reducing the product height by 22.08 mm mm, or by reducing the product length by 19.36 mm and reducing the product width by 38.71 mm.

3. Modifying a Product Design to Reduce Shipping Costs

One of the goals of package design is to fit as many packages as possible onto a pallet. Among the possible modifications of a product design that may increase the number of packages that fit on a pallet are:
Reduce one or more product dimensions so that a smaller package may be used.
Changing the fragility rating so that a thinner cushion is required.
Changing the product orientation.
Change the location of accessories.

Referring back to the example shown in FIG. 15, the Outputs section 68 of the graphical user interface 64 shows that the total number of packages that can fit on a single pallet with the product in the second design state (i.e., Opt2) can be increased by reducing the product height by 10.19 mm, or by reducing the product length by 20 mm and reducing the product width by 39.99 mm.

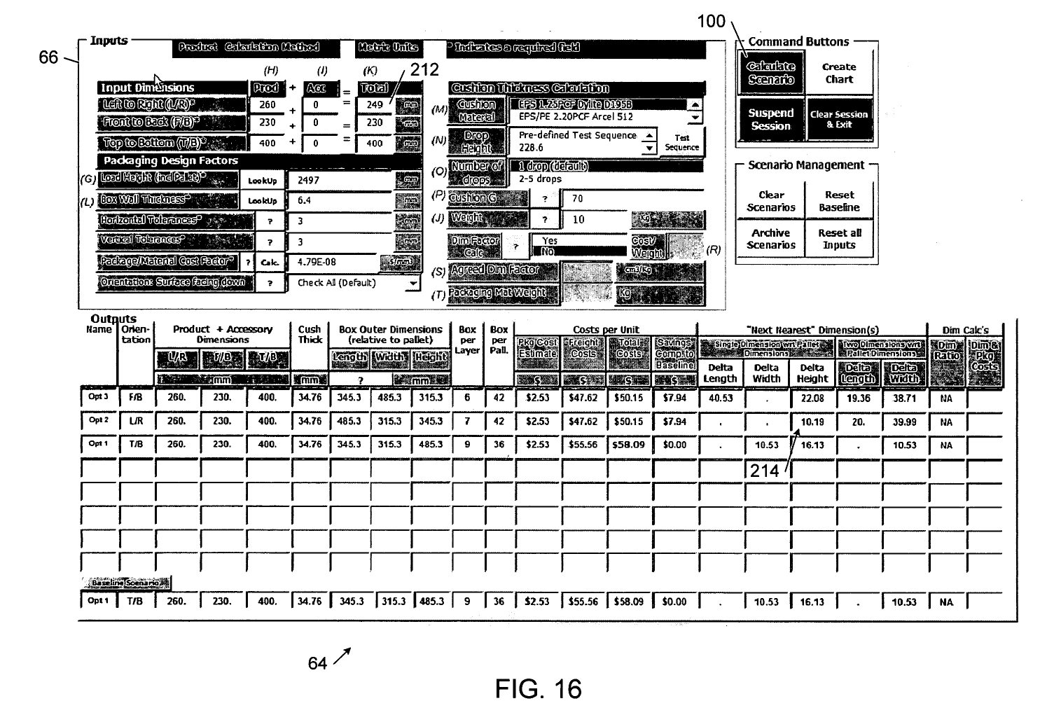

FIG. 16 shows the graphical user interface 64 after the user has transformed the product into a second design state in which the left to right (L/R) dimension 212 is reduced by 11 mm (i.e., from 260 mm to 249 mm) in accordance with the height modification 214 proposed for the second scenario Opt2. (Note: in the product orientation of the second scenario, the next nearest height dimension corresponds to the left to right dimension (i.e., the product+accessory length).)

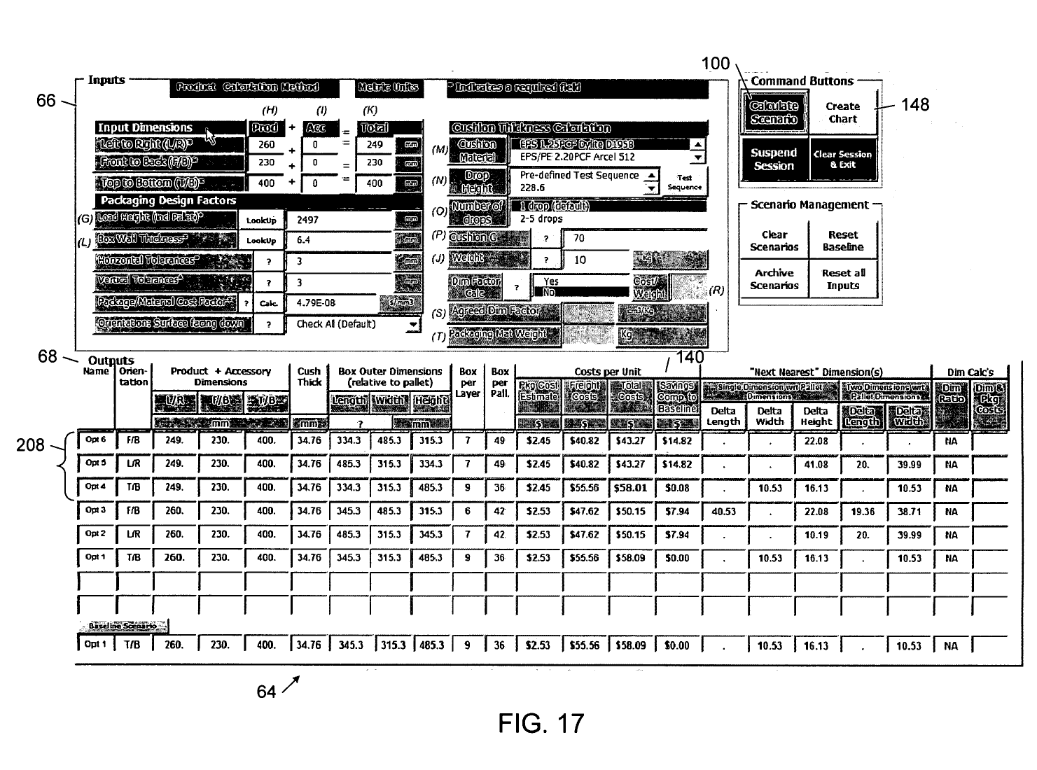

FIG. 17 shows the graphical user interface 64 after the user has selected the Calculate Scenario button 100, which causes the shipping item analysis system 24 to calculate new scenarios 216 (i.e., Opt. 4, Opt5, and opt6) for the three possible orientations of the second design state of the product on the specified pallet. As shown in the Outputs section 68 of the graphical user interface 64, the fifth and sixth scenarios (i.e., Opt5 and Opt6) have the largest number (i.e., 49) of boxes per pallet and offers the largest total cost savings per unit (i.e., $14.82) compared to the baseline scenario (i.e., Opt1).

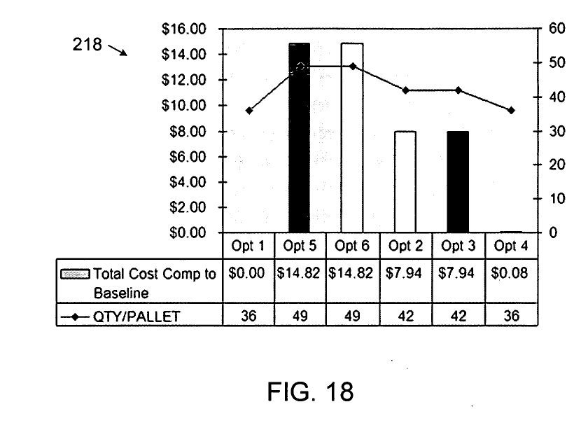

FIG. 18 shows a chart 218 that the shipping item analysis system 24 created in response to the user's selection of the Create Chart button 148 in the graphical user interface 64 shown in FIG. 17. The chart 218 compares the different scenarios in terms of total cost compared to baseline and total number of boxes per pallet. The chart 218 graphically shows that the fifth and sixth scenarios (i.e., Opt5 and Opt6) are superior to all of the other scenarios in terms of total costs per unit and number of boxes per pallet.

VII. Conclusion

The embodiments that are described in detail herein provide systems and methods of evaluating the design of a particular shipping item (e.g., either the initial product design or the initial packaging design) and identifying potential modifications of the shipping item design that would reduce shipping costs at an early stage in the design process (e.g., by increasing the density of shipping items within the same shipping container volume). Some embodiments are capable of evaluating the cost impact of a wide variety of different shipping item parameters, including size, weight, robustness, and shipping orientation of a product, and thickness and material type of the packaging for the product. These embodiments also are able to identify specific modifications of a shipping item design, as well as the estimated cost savings associated with the modifications. In this way, these embodiments enable product engineers and packaging engineers to jointly identify cost-effective product and packaging designs that reduce shipping costs. Other embodiments are within the scope of the claims.

What is claimed is:

1. A machine-implemented method of identifying one or more potential modifications of a shipping item's design, comprising:
identifying a first number of homogeneous copies of the shipping item in a first design state that fit on a specified shipping pallet; and
computing one or more modifications of the shipping item's design to transform the first design state into a second design state of the shipping item homogeneous copies of which fit on the specified shipping pallet in a second number greater than the first number.

2. The method of claim 1, wherein the identifying comprises selecting one of a set of pallet layouts corresponding to a maximal number of the homogeneous copies of the shipping item in the first design state fitting on the specified shipping pallet.

3. The method of claim 2, wherein the selecting comprises evaluating one or more sets of linear constraints constraining dimensions of potential design states of the shipping item that fit on the specified shipping pallet in accordance with associated ones of the pallet layouts, and identifying one or more of the pallet layouts that are associated with sets of linear constraints that are satisfied by the shipping item in the first design state.

4. The method of claim 3, wherein the evaluating comprises evaluating the sets of linear constraints in order of pallet layout ranked by numbers of shipping items in the pallet layouts.

5. The method of claim 4, wherein the selecting comprises selecting the highest ranked identified pallet layout.

6. The method of claim 1, wherein the identifying comprises evaluating different orientations of the shipping item in the first design state on the specified shipping pallet and selecting one of the orientations corresponding to a maximal number of the homogeneous copies of the shipping item in the first design state fitting on the specified shipping pallet, wherein the identified first number is the maximal number.

7. The method of claim 1, wherein the identified first number is associated with a first pallet layout of the homogeneous copies of the shipping item in the first design state on the specified shipping pallet, and the computing comprises identifying a second pallet layout different from the first pallet layout and containing a larger number of homogeneous packages than the first number.

8. The method of claim 7, wherein the computing additionally comprises ascertaining one or more modifications to the first design state of the shipping item needed to produce the second design state of the shipping item with dimensions allowing homogeneous copies of the shipping item in the second design state to fit on the specified shipping pallet in accordance with the second pallet layout.

9. The method of claim 8, wherein the ascertaining comprises evaluating one or more linear constraints associated with the second pallet layout and constraining dimensions of potential design states of the shipping item that fit on the specified shipping pallet in accordance with associated ones of the pallet layouts, and computing modifications to one or more dimensions of the shipping item in the first design state needed to allow the shipping item to satisfy the one or more linear constraints.

10. The method of claim 1, wherein the identifying comprises identifying the first number of homogeneous copies of a first package that fit on the specified shipping pallet, and the computing comprises computing one or more modifications of the first package to form a second package homogeneous copies of which fit on the specified shipping pallet in a greater number than the first package.

11. The method of claim 1, wherein the shipping item is a product, the identifying comprises identifying the first number of homogeneous copies of a first package containing the product in the first design state that fit on the specified shipping pallet, and the computing comprises computing one or more modifications of the product's design to transform the first design state to a second design state of the product contained in a second package homogenous copies of which fit on the specified shipping pallet in a greater number than the first number.

12. The method of claim 11, wherein the computing additionally comprises determining parameters of the second package.

13. The method of claim 12, wherein the identified first number is associated with a first pallet layout of the homogeneous copies of the first package on the specified shipping pallet, and the computing comprises identifying a second pallet layout different from the first pallet layout and containing a larger number of homogeneous packages than the first number.

14. The method of claim 13, wherein the computing additionally comprises ascertaining one or more modifications to the first package needed to produce the second package with dimensions allowing homogeneous copies of the second package to fit on the specified shipping pallet in accordance with the second pallet layout.

15. The method of claim 12, wherein the computing comprises ascertaining dimensions of available volume within the second package.

16. The method of claim 15, wherein the ascertaining comprises determining a thickness of cushion material within the second package.

17. The method of claim 16, wherein the computing comprises computing changes to one or more dimensions of the product needed to transform the product from the first design state to the second design state having dimensions fitting within the ascertained available volume of the second package.

18. The method of claim 11, further comprising calculating dimensions of the first package from specified parameters of the first design state of the product and specified package design parameters.

19. The method of claim 18, wherein the calculating comprises determining a thickness of a specified cushion material within the first package from one or more specified parameters defining a target robustness of the first design state of the product.

20. The method of claim 1, further comprising computing an estimate of a potential cost difference between shipping the second number of homogeneous copies of the second design state of the shipping item on the specified shipping pallet and shipping the first number of homogeneous copies of the first design state of the shipping item on the specified shipping pallet.

21. A system for identifying one or more potential modifications of a shipping item's design, the system comprising one or more data processing modules operable to perform operations comprising:
identifying a first number of homogeneous copies of the shipping item in a first design state that fit on a specified shipping pallet; and
computing one or more modifications of the shipping item's design to transform the first design state into a second design state of the shipping item homogeneous copies of which fit on the specified shipping pallet in a second number greater than the first number.

22. The system of claim 21, wherein one or more of the data processing modules are operable to select one of a set of pallet layouts corresponding to a maximal number of the homogeneous copies of the shipping item in the first design state fitting on the specified shipping pallet.

23. The system of claim 21, wherein one or more of the data processing modules are operable to evaluate different orientations of the shipping item in the first design state on the specified shipping pallet and selecting one of the orientations corresponding to a maximal number of the homogeneous copies of the shipping item in the first design state fitting on the specified shipping pallet, wherein the identified first number is the maximal number.

24. The system of claim 21, wherein the identified first number is associated with a first pallet layout of the homogeneous copies of the shipping item in the first design state on the specified shipping pallet, and one or more of the data processing modules are operable to identify a second pallet layout different from the first pallet layout and containing a larger number of homogeneous packages than the first number.

25. The system of claim 21, wherein one or more of the data processing modules are operable to identify the first number of homogeneous copies of a first package that fit on the specified shipping pallet, and one or more of the data processing modules are operable to compute one or more modifications of the first package to form a second package homogeneous copies of which fit on the specified shipping pallet in a greater number than the first package.

26. The system of claim 21, wherein the shipping item is a product, one or more of the data processing modules are operable to identify the first number of homogeneous copies of a first package containing the product in the first design state that fit on the specified shipping pallet, and one or more of the data processing modules are operable to compute one or more modifications of the product's design to transform the first design state to a second design state of the product contained in a second package homogenous copies of which fit on the specified shipping pallet in a greater number than the first number.

27. A machine-readable medium storing machine-readable instructions for causing a machine to perform operations comprising:
identifying a first number of homogeneous copies of the shipping item in a first design state that fit on a specified shipping pallet; and
computing one or more modifications of the shipping item's design to transform the first design state into a second design state of the shipping item homogeneous copies of which fit on the specified shipping pallet in a second number greater than the first number.

28. A system for identifying one or more potential modifications of a shipping item's design, comprising:
means for identifying a first number of homogeneous copies of the shipping item in a first design state that fit on a specified shipping pallet; and
means for computing one or more modifications of the shipping item's design to transform the first design state into a second design state of the shipping item homogeneous copies of which fit on the specified shipping pallet in a second number greater than the first number.
